(19) United States
(12) Patent Application Publication
(10) Pub. No.: US 2025/0108639 A1
(43) Pub. Date: Apr. 3, 2025

(54) IMAGE RECORDING DEVICE

(71) Applicant: SEIKO EPSON CORPORATION, Tokyo (JP)

(72) Inventors: Satoshi NAKATA, MATSUMOTO-SHI (JP); Kanji MOMOSE, MATSUMOTO-SHI (JP); Masanari TANAKA, SHIOJIRI-SHI (JP)

(21) Appl. No.: 18/903,973

(22) Filed: Oct. 1, 2024

(30) Foreign Application Priority Data
Oct. 2, 2023 (JP) 2023-171151

(51) Int. Cl. B41J 11/70; B41J 11/00; B41J 11/66; B41J 13/02; B41J 13/03; B41J 29/13

(52) U.S. Cl. CPC B41J 11/706; B41J 11/006; B41J 11/663; B41J 13/025; B41J 13/03; B41J 29/13

(57) ABSTRACT

An image recording device including a cutter cover, the image recording device including: a transport unit configured to transport a medium along a transport path; a recording unit configured to record an image on the transported medium; and a cutting unit provided downstream of the recording unit in a transport direction of the medium, the cutting unit being configured to cut the transported medium. The cutting unit includes: a first cutter configured to cut the medium while moving in a scanning direction intersecting the transport direction; a second cutter opposed to the first cutter; a cutter carriage at which the first cutter is mounted, the cutter carriage being configured to move the first cutter in the scanning direction; and a protruding portion provided in an upper portion of the cutter carriage and protruding upward. A first slit extending internally along the scanning direction is formed in the upper portion of the cutter cover. The protruding portion protrudes from an inside of the cutter cover toward an outside through the first slit.

The present application is based on, and claims priority from JP Application Serial Number 2023-171151, filed Oct. 2, 2023, the disclosure of which is hereby incorporated by reference herein in its entirety.

### BACKGROUND

### 1. Technical Field

The present disclosure relates to an image recording device.

### 2. Related Art

Typically, an image recording device is known as disclosed in JP-A-2023-94695. In the image recording device, when a jam of a sheet such as a recording sheet occurs, a motor for cutting is driven to move a cutter mounted at a cutter carriage to the outside of a sheet passing region.

However, in a case of the image recording device in JP-A-2023-94695, there is a possibility that the cutter is not able to be moved by the motor depending on the degree of jamming of the paper.

### SUMMARY

An image recording device including a cutter cover includes a transport unit configured to transport a medium along a transport path, a recording unit configured to record an image on the transported medium, and a cutting unit provided downstream of the recording unit in a transport direction of the medium, the cutting unit being configured to cut the transported medium, in which the cutting unit includes a first cutter configured to cut the medium while moving in a scanning direction intersecting the transport direction, a second cutter opposed to the first cutter, a cutter carriage at which the first cutter is mounted, the cutter carriage being configured to move the first cutter in the scanning direction, and a protruding portion provided in an upper portion of the cutter carriage and protruding upward, a first slit extending internally along the scanning direction is formed in the upper portion of the cutter cover, and the protruding portion protrudes from an inside of the cutter cover toward an outside through the first slit.

### BRIEF DESCRIPTION OF THE DRAWINGS

FIG. 1 is a perspective view illustrating an image recording device.

FIG. 2 is a perspective view illustrating the image recording device when a reading unit is detached to expose a cutter cover.

FIG. 3 is a cross-sectional view illustrating the image recording device.

FIG. 4 is a perspective view mainly illustrating a cutting unit.

FIG. 5 is a cross-sectional view mainly illustrating the cutting unit.

FIG. 6 is a cross-sectional view mainly illustrating a knob.

FIG. 7 is a perspective view illustrating the image recording device when a door at the back surface is opened to expose a transport path member.

FIG. 8 is a flowchart when a medium is cut using the cutting unit.

### DESCRIPTION OF EMBODIMENTS

Below, the configuration of an image recording device 1 according to the embodiment will be described with reference to the drawings. Note that directions in the drawings will be described using a three-dimensional coordinate system. For the purpose of convenience of explanation, the positive direction of the Z-axis is referred to as an upward direction or upward, or simply referred to as an upward side, and the negative direction thereof is referred to as a downward direction or downward, or simply referred to as a downward side. The positive direction of the X-axis is referred to as a right direction or rightward, or simply referred to as right, and the negative direction thereof is referred to as a left direction or leftward, or simply referred to as left. The position direction of the Y-axis is referred to as a frontward direction or frontward, or simply referred to as front, and the negative direction thereof is referred to as a rearward direction or rearward, or simply referred to as rear.

### 1. Configuration of Image Recording Device

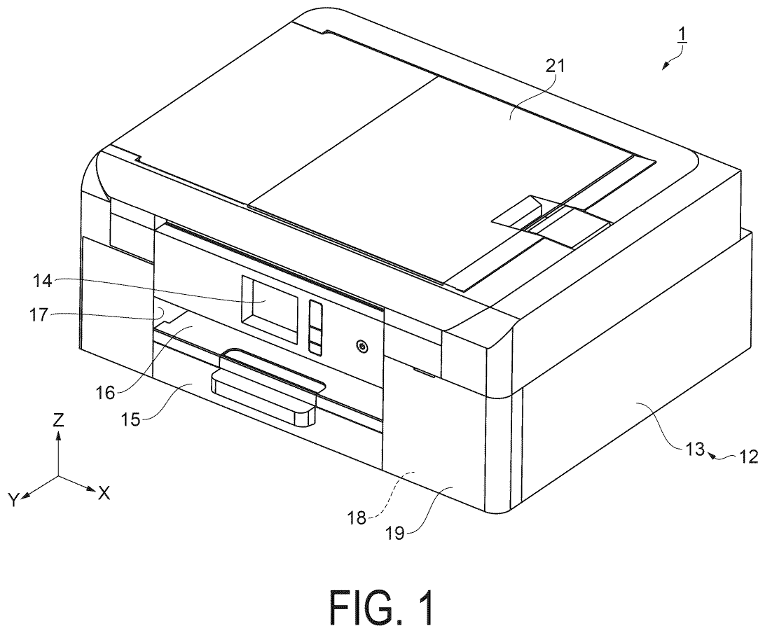

As illustrated in FIG. 1, the image recording device 1 includes a device body 12 and a reading unit 21. The device body 12 is configured to include a housing 13, an input-output unit 14, an accommodation unit 15, a mounting unit 16, and an ink cartridge cover 19.

The accommodation unit 15 is able to accommodate a medium P that will be described later, and is able to be attached to and detached from the inside of the housing 13. Upon the ink cartridge cover 19 being opened, an ink cartridge 18 is able to be mounted within the housing 13.

The accommodation unit 15 and the ink cartridge 18 are disposed in the front of the image recording device 1, and a user is able to attach or detach them from the front of the image recording device 1.

The mounting unit 16 is disposed within the housing 13. The medium P on which recording is performed by a recording unit 40 that will be described later is able to be mounted at the mounting unit 16. A user is able to remove the medium P mounted at the mounting unit 16, from a housing opening 17 disposed in the front. The mounting unit 16 may be configured within the housing 13 so as to be detachable through the housing opening 17. The mounting unit 16 may be configured integrally with the accommodation unit 15.

The input-output unit 14 disposed in the front is a user interface for a user. The input-output unit 14 is, for example, a touch panel display. The input-output unit 14 is a display unit configured to display various types of information, and includes a display panel serving as an output unit, and a detection panel serving as an input unit.

The display panel is a liquid crystal display panel, for example. The detection panel is configured so as to overlap with the display panel. The detection panel is able to detect operation by a finger of the user through a method such as an electrostatic capacitor method, a resistive-film type, or an optical type, for example.

The user is able to perform visual recognition and operations of the input-output unit 14 from the frontward of the image recording device 1.

The reading unit 21 includes an image sensor (not illustrated) such as a contact image sensor (CIS) or a charge coupled device (CCD). With the reading unit 21, the image recording device 1 is able to read an image recorded on the medium P.

Thus, the reading unit 21 enables the image recording device 1 to have functions of a scanner, a copier, a facsimile, or the like, in addition to the function of a printing using the recording unit 40. Such an image recording device 1 is also called a so-called multifunction device or image forming device.

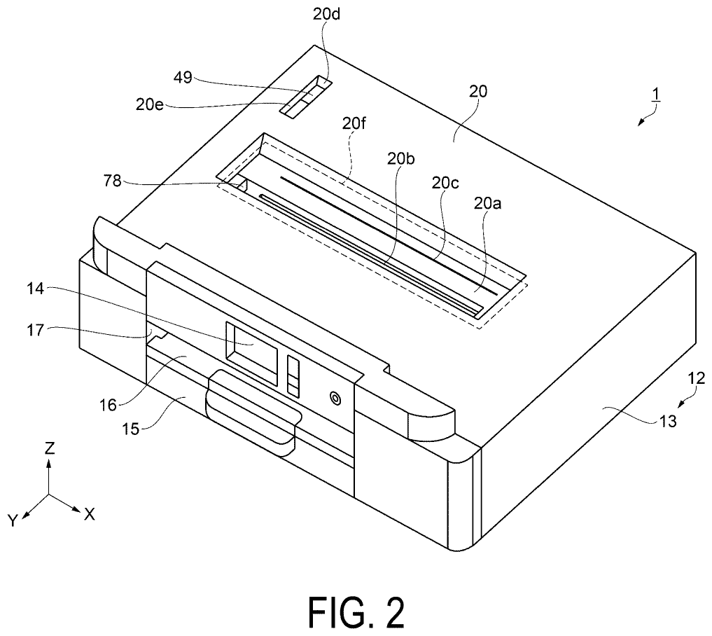

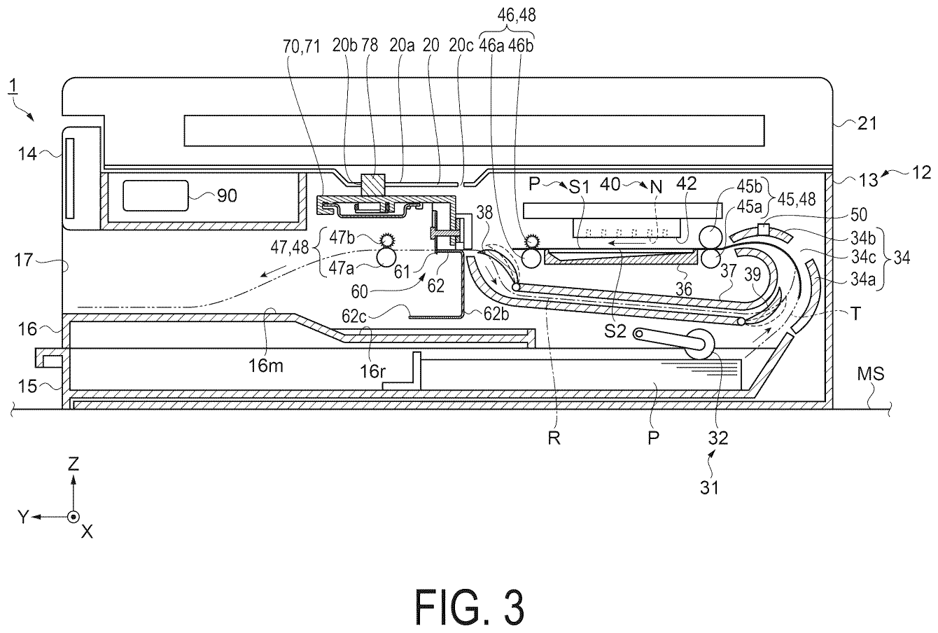

The image recording device 1 includes a cutter cover 20. The configuration of the cutter cover 20 will be described with reference to FIG. 2. FIG. 2 is a diagram in which the reading unit 21 is detached from FIG. 1 to enable the cutter cover 20 to be visually recognized for the purpose of convenience of explanation. The cutter cover 20 at least covers a cutting unit 60 that will be described later with reference to FIG. 3.

The cutter cover 20 includes a first recessed portion 20a formed at or around the center, and the first recessed portion 20a is a recessed portion that is recessed in a rectangular shape elongated in the left-right direction. A lid portion 20f configured to cover the first recessed portion 20a is attached to the cutter cover 20 so as to be opened and closed. When the lid portion 20f is in the closed state, the lid portion 20f prevents a projection 78 serving as a protruding portion that will be described later, from being brought into contact. In addition, the lid portion 20f prevents dust or the like from entering the first recessed portion 20a.

Furthermore, the cutter cover 20 includes a second recessed portion 20d formed at or around the rear left portion, and the second recessed portion 20d is recessed into a rectangular shape elongated in the front-rear direction.

Note that the lid portion 20f may be configured so as to cover the whole of the cutter cover 20. In this case, when the lid portion 20f is in the closes state, the upper surface of the cutter cover 20 is flattened, which enhances the design property. In addition, the lid portion 20f is able to also cover the second recessed portion 20d.

Instead of the lid portion 20f, the reading unit 21 configured to be opened and closed may be configured to cover the whole of the cutter cover 20.

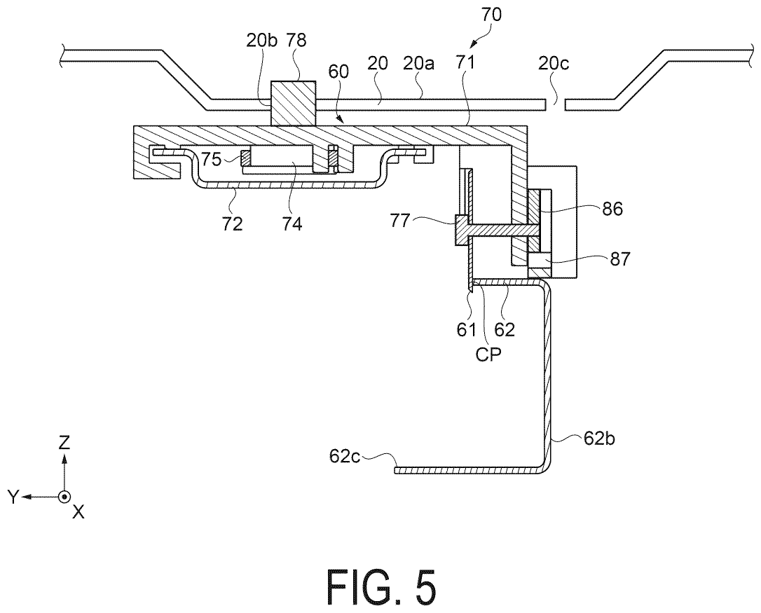

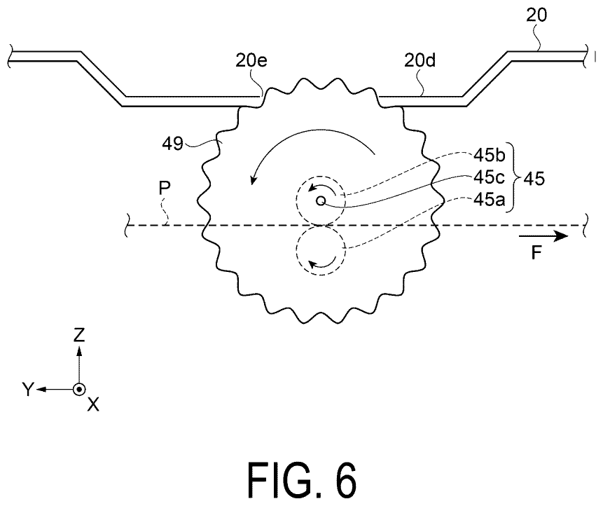

In the cutter cover 20, a first opening 20b that will be described in detail later with reference to FIG. 5 is formed in the first recessed portion 20a. The first opening 20b serves as a first slit, and is an opening that causes the projection 78 to be exposed. In addition, in the cutter cover 20, a second opening 20e that will be described in detail later with reference to FIG. 6 is formed in the second recessed portion 20d. The second opening 20e is an opening that causes a knob 49 serving as a handle grip section to be exposed.

The first opening 20b is formed so as to be elongated in the left-right direction so as to be able to move the projection 78 in the left-right direction that is the width direction of the medium P. The second opening 20e is formed in a manner elongated in the front-rear direction so as to match the shape of knob 49. In addition, in the first recessed portion 20a, a slit 20c serving as a second slit elongated in the left-right direction is formed such that a user can insert a machining cutter and move it in the width direction of the medium P.

Note that the first opening 20b and the slit 20c are formed so as to have the width in the left-right direction longer than the maximum width of the medium P.

As illustrated in FIG. 3, the image recording device 1 includes a substrate 90. A control unit (not illustrated) and a storage unit (not illustrated) are mounted at the substrate 90.

The control unit comprehensively controls each section of the image recording device 1. The control unit is configured so as to include a central processing unit (CPU), a universal asynchronous receiver transmitter (UART) configured to manage input and output, a field programmable gate array (FPGA) that is a logical circuit, a programmable logic device (PLD), and the like. The CPU is also referred to as a processor. The storage unit is configured so as to include a memory such as a writable non-volatile memory or a volatile memory.

The CPU of the control unit reads out a program stored in the non-volatile memory of the storage unit, and executes various types of processing using the volatile memory as a working region.

The configuration of the image recording device 1 will be described with reference to FIG. 3 in the order along the path such as a transport path T through which the medium P is transported. The medium P is, for example, a paper sheet, an envelope, or the like.

The medium P having a predetermined size such as A4 is accommodated in the accommodation unit 15 by a user, and is mounted within the housing 13. The accommodation unit 15 is a so-called tray, and at least the upper and rear portion thereof is opened. Note that the medium P is accommodated in the accommodation unit 15 such that the width direction of the medium P matches the left-right direction of the image recording device 1.

The transport path T through which the medium P is transported is indicated by the long dashed double-short dashed line. In addition, an inversion path R in which the medium P is inverted is indicated by the long dashed short dashed line. The transport direction of the medium P in each of the paths is indicated by the arrows.

From an opening at the upper and rear portion of the accommodation unit 15, a feeding roller 32 of a feeding unit 31 is able to come into contact with the topmost medium P from among stacked media P. As the feeding roller 32 rotates counterclockwise, it is possible to feed the media P one by one from the top to the transport path T.

A transport unit 48 is able to transport, along the transport path T, the medium P fed from the feeding roller 32. The transport unit 48 is disposed in the order of a first roller pair 45, a second roller pair 46, and a third roller pair 47 from upstream toward downstream of the transport direction in the transport path T. Note that, below, the upstream in the transport direction is simply referred to as upstream, and the downstream in the transport direction is simply referred to as downstream. The first roller pair 45 is disposed upstream of the recording unit 40. The second roller pair 46 is disposed between the recording unit 40 and the cutting unit 60 in the transport direction. The third roller pair 47 is disposed downstream of the cutting unit 60.

The first roller pair 45 includes a first main driving roller 45a and a first driven roller 45b. The second roller pair 46 includes a second main driving roller 46a and a second driven roller 46b. The third roller pair 47 includes a third main driving roller 47a and a third driven roller 47b. Each of the roller pairs is able to vertically sandwich the medium P between the main driving roller and the driven roller to transport it. Note that, although each of the main driving rollers is disposed at the lower side and each of the driven rollers is disposed at the upper side, they may be disposed upside down.

The first main driving roller 45a, the second main driving roller 46a, and the third main driving roller 47a are driven by a transport motor (not illustrated). These main driving rollers are linked through a gear or a belt, and are able to rotate in a synchronized manner. These main driving rollers are formed of resin such as rubber.

The first driven roller 45b, the second driven roller 46b, and the third driven roller 47b are able to rotate so as to follow the corresponding opposing main driving roller.

The first roller pair 45, the second roller pair 46, and the third roller pair 47 are linked to each other, and are able to rotate simultaneously.

Since the first roller pair 45 first transports the medium P fed out from the feeding roller 32, the first roller pair 45 needs to have the highest nipping force of the three roller pairs, and the first driven roller 45b is formed of resin such as rubber.

As the second roller pair 46 and the third roller pair 47 are disposed downstream of the recording unit 40 that will be described later, it is preferable that these pairs should not have an effect on the recording result of the medium P. In addition, the second roller pair 46 or the third roller pair 47 does not need to have nipping force similar to the first roller pair 45.

Thus, the second driven roller 46b and the third driven roller 47b are configured to have a shape including a thin toothed-gear shaped protrusion made of a metal such as stainless steel so as to reduce the area that comes into contact with the medium P on which ink is attached. The roller having such a shape is also called a so-called star-wheel roller.

Of the transport path T, a transport path member 34 constitutes a curved portion of the transport path T that is disposed between the accommodation unit 15 and the first roller pair 45. The transport path member 34 causes the transport path T extending upward from the accommodation unit 15 to be curved so as to extend in the frontward direction, thereby guiding it to the first roller pair 45.

The transport path member 34 is configured such that the first transport path member 34a is disposed upstream and the second transport path member 34b is disposed downstream. A hole 34c that is a through hole is formed between the first transport path member 34a and the second transport path member 34b.

A medium sensor 50 configured to be able to detect the medium P existing at the transport path T is provided at the second transport path member 34b of the transport path member 34. The medium sensor 50 may be a photosensor configured to detect the medium P. The medium sensor 50 may be configured with a lever that is able to come into contact with the medium P, a mechanical switch or a photosensor configured to detect the movement of the lever at the time of coming into contact with the medium P, and the like.

The medium sensor 50 is able to detect the medium P existing at a position disposed upstream of the first roller pair 45 in the transport path T.

The recording unit 40 is a head configured to perform recording on the medium P, and is disposed between the first roller pair 45 and the second roller pair 46 and at a position that is opposed to the medium support portion 36 from above. The recording unit 40 includes a discharging surface 42, and the discharging surface 42 includes a plurality of nozzles N configured to discharge a liquid such as ink supplied from the ink cartridge 18 described above. The discharging surface 42 is disposed at a position that is opposed to the medium support portion 36. The medium P is transported by the transport unit 48, and is disposed at a position where the medium P is supported by the medium support portion 36 from below. The medium P includes a first surface S1 that is opposed to the discharging surface 42 of the recording unit 40. The medium P includes a second surface S2 that is a surface opposite from the first surface S1 and supported by the medium support portion 36.

The recording unit 40 is mounted at a recording unit carriage (not illustrated) configured to be able to move left and right with a recording unit motor (not illustrated). The recording unit 40 discharges ink from the nozzles N while moving left and right with the recording unit carriage, thereby recording an image on the first surface S1 of the medium P.

An inversion path member 37 includes two surfaces of an upper surface and a lower surface that are opposed vertically to each other, and an inversion path R is formed between these two surfaces.

A switching unit 38 disposed downstream is provided in a rotatable manner with the center being a shaft extending left and right at a forward end of the upper surface of the inversion path member 37. In addition, a switching unit 39 disposed upstream is provided in a rotatable manner with the center being a shaft extending left and right at a rear end of the lower surface of the inversion path member 37.

The switching units 38 and 39 are able to move between a transporting position indicated by the solid line and a reversing position indicated by the dashed line. As the switching units 38 and 39 move, the path through which the medium P is transported is switched. Note that the switching units 38 and 39 are moved by a plunger (not illustrated) using an electromagnet or a switching unit motor (not illustrated) or the like.

When the switching unit 39 is at the transporting position, the transport path T disposed upstream expands. The medium P is not blocked by the switching unit 39, and is able to be smoothly transported from the accommodation unit 15 along the transport path T. Furthermore, when the switching unit 38 is at the transporting position, the medium P is also not blocked by the switching unit 38, and is able to be smoothly transported from the second roller pair 46 to the third roller pair 47 along the transport path T.

At the time of inverting the medium P, the trailing end of the medium P that is an end, at the upstream, of the medium P departs from the second roller pair 46 of the transport unit 48, and passes through the switching unit 38. Then, the transport unit 48 temporarily stops. At this time, a forward portion of the medium P that is disposed downstream is nipped by the third roller pair 47 of the transport unit 48, and is able to be transported toward the reverse direction in the transport direction.

Note that, when passing through the transport path member 34, the trailing end, at the upstream, of the medium P has already been detected by the medium sensor 50. The control unit of the substrate 90 is able to stop the medium P by the transport unit 48 at a position where the trailing end of the medium P passes through the switching unit 38, on the basis of the medium sensor 50.

Next, the switching units 38 and 39 move to the reversing position. The switching unit 38 rotates to cause the leading end to advance to the transport path T. In this state, the transport unit 48 including the third roller pair 47 is caused to drive in a manner opposite to the transporting time, and transports the medium P by the third roller pair 47 in the reverse direction to the transport direction. That is, the transport unit 48 is reversed.

The switching unit 38 makes it possible to prevent the trailing end of the medium P from returning and advancing toward the transport path T, and expand the inversion path R to guide the medium P such that the medium P is led to the inversion path R from the trailing end. After this, the original trailing end of the medium P becomes the leading end, and is transported through the inversion path R. Note that, below, the original trailing end of the medium P is referred to as the trailing end of the medium P.

The medium P is transported rearward along the inversion path R by the transport unit 48. The medium P is transported by the third roller pair 47 until the trailing end of the medium P reaches the first roller pair 45.

The switching unit 39 disposed rearward is also at the reversing position, and expands the inversion path R. After passing through the inversion path R, the trailing end of the medium P moves the path from the inversion path R to the transport path T, and is smoothly transported.

Once the trailing end of the medium P is detected by the medium sensor 50, the control unit of the substrate 90 causes the medium P to be transported to the position at which the trailing end of the medium P reaches the first roller pair 45 of the transport unit 48, and then, temporarily stops the transport unit 48. The switching units 38 and 39 return to the transporting position.

After this, the transport unit 48 switches drive to drive in a manner similar to that at the time of the first transportation. That is, the transport unit 48 returns back from the reverse.

As is the case with the original state, the first roller pair 45 of the transport unit 48 is able to transport the medium P along the transport path T toward the transport direction. This similarly applies to the other roll pairs.

In this manner, the medium P is inverted. Thus, the second surface S2 of the medium P is now turned into a position that is opposed to the discharging surface 42 of the recording unit 40. The recording unit 40 is able to perform recording on the second surface S2 of the medium P.

Next, the cutting unit 60 is disposed between the second roller pair 46 and the third roller pair 47 in the transport direction. In addition, the cutting unit 60 is provided downstream of the recording unit 40 in the transport direction of the medium P.

The cutting unit 60 is configured to include a movable blade 61 serving as a first cutter, a fixed blade 62 serving as a second cutter, and a moving unit 70. The movable blade 61 has a disk shape, and is also referred to as a so-called circular blade. The fixed blade 62 has a plate shape.

That is, the cutting unit 60 is configured to include the movable blade 61 configured to cut the medium P, and the fixed blade 62 that is opposed to the movable blade 61.

Note that the movable blade 61 is not limited to the circular blade, and may be a cutter blade or the like, for example.

The cutting unit 60 includes the moving unit 70. The moving unit 70 is configured to include a cutter carriage 71 at which the movable blade 61 is mounted. Note that, below, the cutter carriage 71 is simply referred to as a carriage 71. The carriage 71 moves in the left-right direction that is the width direction of the medium P and is also the scanning direction of the movable blade 61.

That is, the movable blade 61 is mounted at the carriage 71, and the carriage 71 causes the movable blade 61 to move in the scanning direction.

The movable blade 61 is also able to cut the medium P existing between the movable blade 61 and the fixed blade 62 while moving together with the carriage 71. That is, the cutting unit 60 moves in the scanning direction intersecting the transport direction, and is able to cut the medium P transported by the transport unit 48.

Such a cutting unit 60 is called an automatic cutter, with respect to a so-called manual cutter that cuts the medium P with a hand.

The medium P that has been cut by the cutting unit 60 is mounted at the mounting unit 16 disposed below. The front portion of the cut medium P disposed downstream is mounted at a first mounting unit 16m. The rear portion of the cut medium P disposed upstream is mounted at a second mounting unit 16r.

In addition, the slit 20c of the cutter cover 20 is disposed between the second roller pair 46 and the cutting unit 60 in the transport direction.

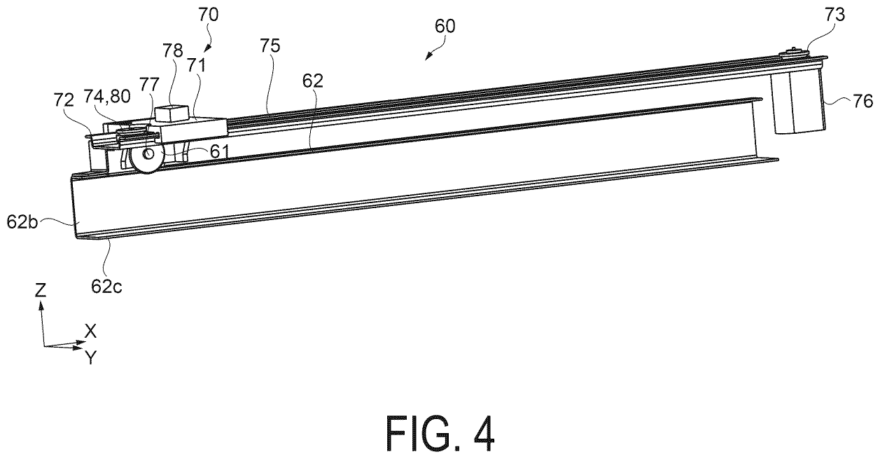

Next, the configuration of the cutting unit 60 will be described with reference to FIGS. 4 to 6. As illustrated in FIG. 4, the cutting unit 60 is configured to include the movable blade 61, the fixed blade 62, and the moving unit 70. The moving unit 70 is configured to include the carriage 71, a carriage guide 72, pulleys 73 and 74, an endless belt 75, a carriage motor 76, and a sensor 80.

The pulley 74 is disposed at the left end of the carriage guide 72, and the pulley 73 is disposed at the right end thereof. The endless belt 75 is looped over the pulleys 73 and 74. The pulley 73 is fixed at the drive shaft of the carriage motor 76. The carriage 71 is attached to the endless belt 75.

As the carriage motor 76 drives, the pulleys 73 and 74 rotate and the endless belt 75 circulates. At this time, the carriage 71 attached to the endless belt 75 moves left and right. The movable blade 61 mounted at the carriage 71 also moves.

The movable blade 61 is rotatably supported by a toothed gear shaft 77 mounted at the carriage 71. A side wall 62b vertically extending and a side wall 62c continuing from the side wall 62b are provided at the fixed blade 62.

A projection 78 is provided at an upper portion of the carriage 71, and is a protruding portion that protrudes upward. A user holds the projection 78 with fingers, thereby being able to move the carriage 71 left and right.

The sensor 80 is, for example, a rotary encoder. The control unit of the substrate 90 is able to determine the position of the carriage 71 and the movement of the carriage 71 on the basis of the detection information from the sensor 80. Note that, below, determining the position of the carriage 71 and the movement of the carriage 71 by the control unit on the basis of the detection information from the sensor 80 is also expressed simply as the sensor 80 detecting the position of the carriage 71 and the movement of the carriage 71 by omitting the “control unit” and “detection information”.

By detecting the rotation of the pulley 74, the sensor 80 is able to detect the position of the carriage 71 and the movement of the carriage 71. The position of the carriage 71 and the movement of the carriage 71 that the sensor 80 detects are also the position of the movable blade 61 and the movement of the movable blade 61.

Note that, when the reference position of the carriage 71 is set to the left end of the carriage guide 72, the medium P is cut by the movable blade 61 when the carriage 71 moves from the reference position toward the right direction. When returning after cutting, the carriage 71 moves in the left direction, and stops once reaching the reference position. The reference position of the carriage 71 is also referred to as a home position.

The control unit of the substrate 90 causes the carriage 71 to move in the left direction during the initialization operation of the carriage 71. The control unit may set the reference position as a position at which the sensor 80 does not detect the movement of the carriage 71, for example, due to the carriage 71 coming into contact with the housing 13 or the like. It may be possible to install a home-position sensor at the reference position to detect the reference position.

In addition, it is possible to set the reference position at the right end of the carriage guide 72. In this case, it may be possible to cut the medium P by the movable blade 61 when the carriage 71 moves in the left direction.

As illustrated in FIG. 5, the movable blade 61 is mounted at the carriage 71, and the carriage 71 is attached to the endless belt 75 to move.

At this time, a toothed gear 86 mounted at the carriage 71 meshes with a rack 87 fixed to the housing 13 to rotate. At the same time, the toothed gear shaft 77 of the toothed gear 86 also rotates. The toothed gear shaft 77 of the toothed gear 86 also serves as a shaft of the movable blade 61. That is, the movable blade 61 is comprised of the toothed gear shaft 77 coaxial with the toothed gear 86. The movable blade 61 attached to the toothed gear shaft 77 also rotates in association with the rotation of the toothed gear 86.

The movable blade 61 that moves while rotating due to the carriage 71 slides at the cutting position CP with respect to the fixed blade 62 having a plate shape, thereby being able to cut the medium P existing between the movable blade 61 and the fixed blade 62.

Here, description will be made of a process made by a user when the medium P is jammed up at the cutting unit 60. When the medium P is jammed up, the carriage 71 may not be moved only by a torque of the carriage motor 76. Note that jamming up of the medium P within the device such as the image recording device 1 is also referred to as a paper jam or a so-called paper jam.

In this case, a user is able to move the projection 78 toward the left-right direction that is the width direction of the medium P. The first opening 20b is formed in the upper portion of the cutter cover 20. The first opening 20b serves as the first slit extending through the inside along the scanning direction. The projection 78 protrudes, through the first opening 20b, from the inside of the cutter cover 20 toward the outside.

The projection 78 is exposed from the first opening 20b, and allows a user to hold. Even when the carriage 71 cannot be moved by a torque of the carriage motor 76 due to paper jam, the user is able to move the carriage 71 using the projection 78. In association with the movement of the projection 78, the movable blade 61 together with the carriage 71 moves, which makes it possible to cut the jammed medium P in the width direction.

In addition, the upper portion of the cutter cover 20 includes the slit 20c provided in parallel to the first opening 20b and extending through the inside along the scanning direction. A user is able to insert a machining cutter from the slit 20c of the cutter cover 20. The slit 20c is disposed upstream of the first opening 20b.

The machining cutter is able to reach the position of the fixed blade 62 of the cutting unit 60, and is able to reach the position of the jammed medium P. In addition, the user is able to move the machining cutter along the slit 20c in the left-right direction, thereby being able to cut the jammed medium P in the width direction. When the jammed medium P cannot be cut even by moving the projection 78, the user is able to cut it using the machining cutter.

The first recessed portion 20a recessed downward from the upper surface is formed in the cutter cover 20. The space formed by the first recessed portion 20a allows a user to easily operate the projection 78 or the machining cutter with user's hand.

In addition, the first recessed portion 20a enables the height position of the top portion of the projection 78 to be lower than the upper surface of the cutter cover 20. Thus, the projection 78 does not interfere with the cutter cover 20 or the reading unit 21.

After a user operates the projection 78 or the machining cutter to cut the jammed medium P, the medium P that has been cut remains at or around the cutting unit 60. A portion, at the upstream, of the medium P that has been cut in the width direction is sandwiched by at least the second roller pair 46. In addition, the portion, at the upstream, of the medium P may be sandwiched by the first roller pair 45.

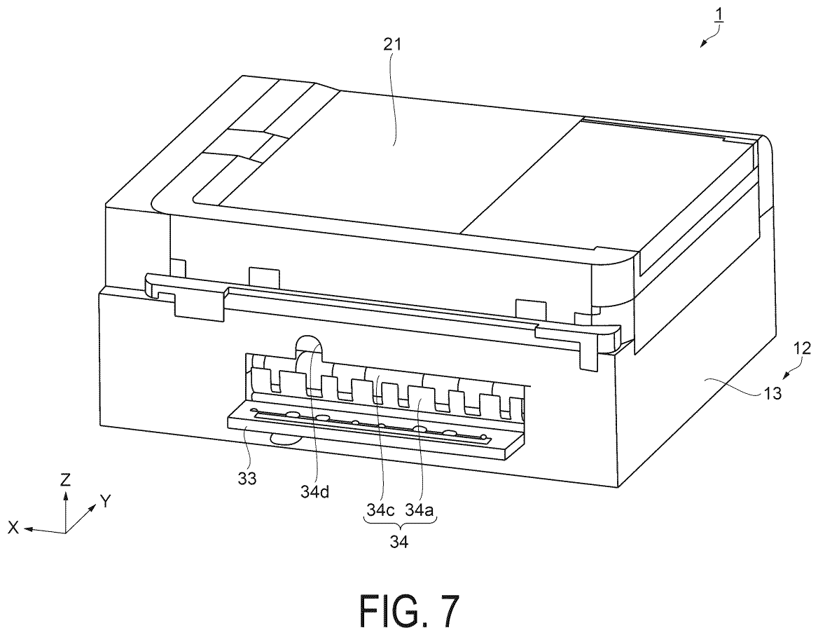

FIG. 6 illustrates a state in which the portion, at the upstream, of the medium P is sandwiched by the first roller pair 45 for the purpose of convenience of explanation following FIG. 7 that will be described later, and this similarly applies to the case of the second roller pair 46.

As illustrated in FIG. 6, an emergency knob 49 is attached to the shaft 45c of the first driven roller 45b of the first roller pair 45, the shaft 45c being a rotary shaft. The first driven roller 45b and the knob 49 are linked to each other with the same shaft 45c. The knob 49 is exposed from the second opening 20e.

As a user rotates the knob 49 counterclockwise, the first driven roller 45b linked to the shaft 45c also rotates counterclockwise.

The first roller pair 45, the second roller pair 46, and the third roller pair 47 are linked to each other as described above. As the first driven roller 45b is rotated counterclockwise, these roller pairs also rotate at the same time.

This configuration makes it possible to transport the medium P existing between the first main driving roller 45a and the first driven roller 45b toward the removing direction F that is the rearward direction. In addition, when the medium P exists at the second roller pair 46, it is possible to transport it toward the first roller pair 45 that is the rearward direction.

The second recessed portion 20d is formed in the cutter cover 20. The space formed by the second recessed portion 20d allows a user to easily operate the knob 49 with user's hand. In addition, the second recessed portion 20d enables the knob 49 to be disposed at a position at which the knob 49 does not interfere with the cutter cover 20 or the reading unit 21.

Note that a portion, at the downstream, of the medium P that has been cut by the user is sandwiched by the third roller pair 47. The third roller pair 47 does not have nipping force similar to the first roller pair 45. Before operating the knob 49, the user is able to easily pull out the portion, at the downstream, of the medium P through the housing opening 17 from the third roller pair 47 side where the nipping force is low.

Note that the knob 49 may be attached to the first main driving roller 45a of the first roller pair 45. With this configuration, it is possible to transport the medium P as in the case where the knob 49 is attached to the first driven roller 45b.

Since the first roller pair 45, the second roller pair 46, and the third roller pair 47 are linked to each other as described above, the knob 49 may be attached to the second roller pair 46 or the third roller pair 47.

That is, it is possible to provide the knob 49 at at least one roller pair of the first roller pair 45, the second roller pair 46, and the third roller pair 47 such that the knob 49 is provided at the rotary shaft of one of rollers that constitute this one roller pair, the knob 49 being configured to rotate on this rotary shaft.

In addition, the user is able to rotate the knob 49 clockwise to transport the portion, at the downstream, of the medium P to the housing opening 17, and remove it.

As illustrated in FIG. 7, a door 33 serving as a door section that can be opened and closed is provided at the back surface, which is the rearward, of the housing 13 of the device body 12. Upon opening the door 33, the transport path member 34 is exposed.

As described above, the transport path member 34 constitutes the curved portion of the transport path T that is disposed in the transport path T and between the accommodation unit 15 and the first roller pair 45. In addition, the transport path member 34 is configured such that the first transport path member 34a is disposed upstream in the transport direction and the second transport path member 34b is disposed downstream. Note that, in FIG. 7, the second transport path member 34b is disposed within the housing 13, and is hidden.

The hole 34c that is a through hole is formed between the first transport path member 34a and the second transport path member 34b. The hole 34c is disposed at the same height as the first roller pair 45. As described later, the hole 34c is an opening used by a user to take the jammed medium P out. That is, the hole 34c that is a through hole extending through the inside is formed in the transport path member 34 that is a portion of the transport path T that corresponds to the upstream of the first roller pair 45 in the transport direction, and the hole 34c is disposed at the same height position as the first roller pair 45.

As described with reference to FIGS. 6 to 7, a user rotates the knob 49 counterclockwise, thereby being able to smoothly transport the portion, at the upstream, of the medium P that has been cut, from the first roller pair 45 toward the hole 34c of the transport path member 34 in the removing direction F that is the rearward.

This medium P is transported to the position of the hole 34c of the transport path member 34, which makes it possible to expose it from the hole 34c. A user is able to grab this medium P from the hole 34c with its hand to easily remove it. It is possible to prevent a user from pulling the jammed medium P to tear the medium P off to leave it there.

In addition, the housing 13 includes a hole 34d formed so as to communicate with the hole 34c. The hole 34d is a small notch that allows a finger or hand to be inserted into. The inner peripheral surface of the hole 34d has a curved surface. Upon the door 33 being opened, the hole 34d is exposed. A user inserts a finger or hand from the hole 34d toward the hole 34c. This makes it easy to grab the medium P, which makes it possible to easily remove the medium P from the inside of the housing 13 to the outside.

Due to the medium P jamming up at the cutting unit 60, there is a possibility that the movable blade 61 mounted at the carriage 71 of the cutting unit 60 cannot be moved. With the configuration of the image recording device 1 described above, a user can cut the jammed medium P by operating the projection 78 or the machining cutter.

In addition, by operating the knob 49, the user can transport the cut medium P to the housing opening 17 or the hole 34c of the transport path member 34, and remove it. The cutting unit 60 can cut the medium P again.

### 2. Method of Controlling Image Recording Device

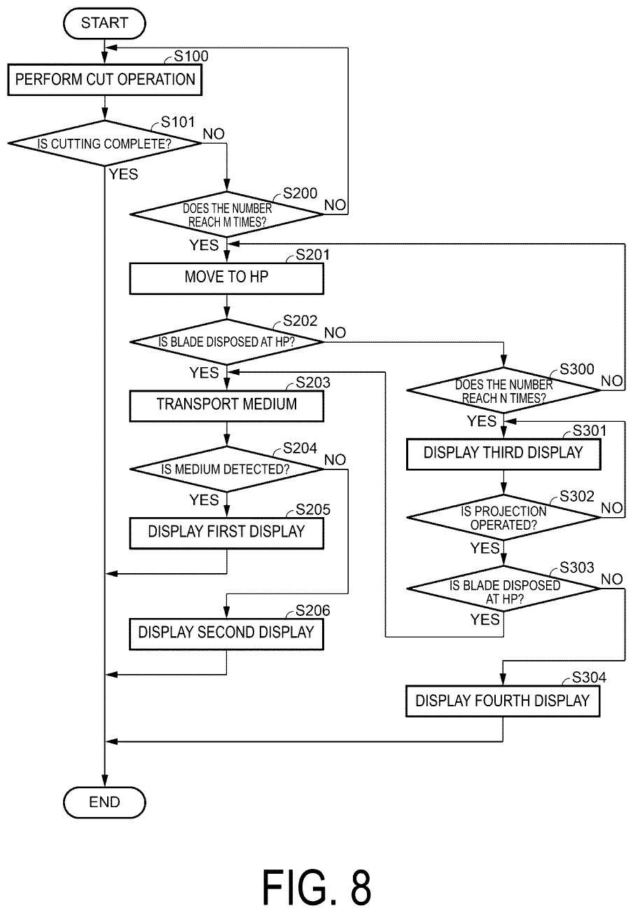

A method of controlling the image recording device 1 will be described with reference to FIG. 8. It is assumed that the carriage 71 of the moving unit 70 of the cutting unit 60 and the movable blade 61 of the cutting unit 60 that is mounted at the carriage 71 are disposed at the reference position that is a predetermined position. Note that description below will be made with focus being placed on the movable blade 61 and without explaining the carriage 71. In addition, the home position that is the reference position is referred to as an HP.

As described above with reference to FIG. 4, the control unit mounted at the substrate 90 performs a cutting operation in which the carriage motor 76 of the moving unit 70 is caused to drive to move the movable blade 61 rightward from the HP, thereby cutting the medium P (S100).

At this time, the control unit detects the movement of the movable blade 61 by the sensor 80, and determines whether or not the movable blade 61 moves across the entire width of the medium P and the medium P can be cut (S101).

When detecting by the sensor 80 that the movable blade 61 moves across the entire width of the medium P and determining that the medium P can be cut (S101: YES), the control unit ends the process.

On the other hand, when detecting by the sensor 80 that the movable blade 61 does not move across the entire width of the medium P and determining that the medium P cannot be cut (S101: NO), the control unit stops the carriage motor 76, and counts the number of times of the cutting operations being performed. This is because there is a case in which the movable blade 61 cannot move across the entire width of the medium P due to the jammed medium P.

The control unit determines whether or not the number of times of the cutting operation reaches M times (S200). For example, the M times is 10 times.

Upon determining that the number of times of the cutting operation does not reach M times (S200: NO), the cutting operation is repeated again (S100).

That is, when the medium P cannot be cut, the control unit repeats the cutting operation until the number of times of the cutting operation reaches the M times. This is because the cutting unit 60 may successfully cut the medium by repeating the cutting operation.

On the other hand, upon determining that the number of times of the cutting operation reaches M times (S200: YES), the control unit drives the carriage motor 76 to perform an operation of moving the movable blade 61 toward the HP (S201). At this time, the control unit can determine that the cutting unit 60 fails to properly cut the medium P. This is because it is highly likely that the cutting unit 60 cannot cut the medium even by repeating the cutting operation.

The control unit determines, by using the sensor 80, whether or not the movable blade 61 returns to the HP and stays at the HP (S202). When determining that the movable blade 61 is at the HP (S202: YES), the control unit causes the transport unit 48 to transport the medium P by a predetermined length (S203). The predetermined length is a length with which the upstream end of the medium P exceeds the position of the medium sensor 50 disposed at the transport path member 34.

The control unit determines, by using the medium sensor 50, whether or not the medium P is detected (S204).

When determining that the medium P is detected by using the medium sensor 50 (S204: YES), the control unit displays first display information using the input-output unit 14 (S205), and ends the process. Below, the first display information is simply referred to as first display.

When the transport unit 48 correctly performs transporting by the predetermined length, the upstream end of the medium P exceeds the position of the medium sensor 50, which means that the medium P is disposed at a position at which the medium sensor 50 does not detect the medium P.

On the other hand, when the medium P is disposed at the position at which the medium sensor 50 can detect the medium P, this means that the transport unit 48 cannot correctly transport it by the predetermined length. In this case, the control unit can determine that a paper jam occurs at the transport unit 48.

The first display displayed by the input-output unit 14 includes details displaying an error in which a paper jam occurs at the transport unit 48. The first display may include details displaying an error in which the medium P cannot be correctly cut at the cutting unit 60.

When determining that the transport unit 48 correctly transports the medium by the predetermined length and the medium sensor 50 does not detect the medium P (S204: NO), the control unit causes the input-output unit 14 to display second display information (S206), and ends the process. Below, the second display information is simply referred to as second display. The second display includes details displaying an error in which the medium P cannot be correctly cut at the cutting unit 60.

When determining that the movable blade 61 does not return to the HP and does not exist at the HP (S202: NO), the control unit causes the carriage motor 76 to stop, and determines whether or not the number of attempts to move the movable blade 61 to the HP reaches the N times (S300). This is because there is a case in which the movable blade 61 cannot return to the HP due to the jammed medium P. The N times is less than the M times, and is five times, for example.

When determining that the number of attempts to move the movable blade 61 to the HP does not reach the N times (S300: NO), the control unit repeats moving the movable blade 61 to the HP again (S201). This is because the movable blade 61 may successfully return to the HP if the moving unit 70 repeats moving the movable blade 61.

On the other hand, when determining that the number of attempts to move the movable blade 61 to the HP reaches the N times (S300: YES), the control unit causes the input-output unit 14 to display third display information (S301). Below, the third display information is simply referred to as third display.

This is because it is highly likely that the movable blade 61 cannot be returned to the HP even by repeating moving the movable blade 61. The control unit can determine that the movable blade 61 cannot be correctly moved to the HP and the medium P is jammed up at the cutting unit 60.

The third display includes details displaying that a user is prompted to move the projection 78 to cut the jammed medium P, and then, move the projection 78 to the HP at the left. The third display may include details displaying that a user is prompted to insert a machining cutter into the slit 20c, and move it to cut the jammed medium P. The third display may include details displaying that a user is prompted to rotate the knob 49 to remove the cut medium P.

In addition, the third display may include details that prompt a user to cut and remove the jammed medium P, and then, operate the input-output unit 14 to input the fact that the jammed medium P is cut and is removed.

That is, when the movable blade 61 does not return to the HP, the control unit causes the carriage motor 76 to stop to stop the cutting unit 60, and indicates that the projection 78 should be operated, on the basis of detection information from the sensor 80.

The control unit is able to clearly suggest to a user a method of dealing with a paper jam. This improves the convenience of a user dealing with the image recording device 1.

The user is able to visually recognize the third display through the input-output unit 14. On the basis of the third display, the user moves the projection 78 to move the movable blade 61 together with the carriage 71, thereby being able to cut the jammed medium P. At this time, it may be possible to employ a configuration in which the user inserts a machining cutter into the slit 20c, and moves it to cut the jammed medium P. By rotating the knob 49, the user is able to remove the medium P that has been cut. After removing the jammed medium P that has been cut, the user is able to move the projection 78 to the HP at the left.

After this, the user operates the input-output unit 14 to input, into it, the fact that the jammed medium P is cut and is removed.

On the basis of the input by the user into the input-output unit 14, the control unit determines whether or not the user operates the projection 78 or the like (S302).

When determining that the user does not operate the projection 78 or the like (S302: NO), the control unit repeats displaying the third display (S301).

On the other hand, when determining that the user operates the projection 78 or the like (S302: YES), the control unit determines, by the sensor 80, whether or not the movable blade 61 exists at the HP as a result of the operation of the projection 78 or the like (S303).

When determining that the movable blade 61 does not exist at the HP (S303: NO), the control unit displays fourth display information through the input-output unit 14 (S304), and ends the process. Below, the fourth display information is simply referred to as fourth display.

The fourth display includes details displaying an error in which the movable blade 61 cannot be returned to the HP even if the user operates the projection 78 or the like. The fourth display may include details displaying an error in which the medium P is jammed up at the cutting unit 60. In addition, the fourth display may include details displaying an error in which the medium P cannot be correctly cut at the cutting unit 60.

On the other hand, when determining that the movable blade 61 exists at the HP (S303: YES), the control unit moves to a process of transporting the medium P using the transport unit 48 described above (S203). Processes thereafter are similar to those described above.

With the embodiment described above, the image recording device 1 including the cutter cover 20 includes: the transport unit 48 configured to transport the medium P along the transport path T; the recording unit 40 configured to record an image on the transported medium P; and the cutting unit 60 provided downstream of the recording unit 40 in a transport direction of the medium P, the cutting unit 60 being configured to move in the scanning direction intersecting the transport direction to cut the transported medium P.

The cutting unit 60 includes: the movable blade 61 configured to cut the medium P while moving; the fixed blade 62 that is opposed to the movable blade; the carriage 71 at which the movable blade 61 is mounted, the carriage 71 being configured to move the movable blade 61 in the scanning direction; and the projection 78 provided in the upper portion of the carriage 71 and protruding upward.

The first opening 20b extending internally along the scanning direction is formed in the upper portion of the cutter cover 20, and the projection 78 protrudes from an inside of the cutter cover 20 toward an outside through the first opening 20b.

With the image recording device 1 having such a configuration, even when the medium P is jammed up at the cutting unit 60 or the like and the carriage 71 cannot be moved by a torque of the carriage motor 76, a user is able to move the carriage 71 using the projection 78. In association with the movement of the projection 78, the movable blade 61 together with the carriage 71 moves, which makes it possible to cut the jammed medium P in the width direction.

By operating the knob 49, the user is able to transport the cut medium P to the housing opening 17 or the hole 34c of the transport path member 34 to remove it.

These are detailed description of the embodiment with reference to the drawings. However, specific configurations are not limited to this embodiment, and may be modified, replaced, deleted, or the like, provided that these do not depart from the main point of the present disclosure.

What is claimed is:

1. An image recording device including a cutter cover, comprising:
a transport unit configured to transport a medium along a transport path;
a recording unit configured to record an image on the transported medium; and
a cutting unit provided downstream of the recording unit in a transport direction of the medium, the cutting unit being configured to cut the transported medium, wherein
the cutting unit includes:
a first cutter configured to cut the medium while moving in a scanning direction intersecting the transport direction;
a second cutter opposed to the first cutter;
a cutter carriage at which the first cutter is mounted, the cutter carriage being configured to move the first cutter in the scanning direction; and
a protruding portion provided in an upper portion of the cutter carriage and protruding upward,
a first slit extending internally along the scanning direction is formed in the upper portion of the cutter cover, and
the protruding portion protrudes from an inside of the cutter cover toward an outside through the first slit.

2. The image recording device according to claim 1, wherein
a portion of the cutter cover where the first slit is formed includes a recessed portion recessed downward from the upper surface of the cutter cover, and
a height position of a top portion of the protruding portion is lower than the upper surface.

3. The image recording device according to claim 2, further comprising
a lid portion configured to open and close the recessed portion.

4. The image recording device according to claim 1, further comprising
a second slit provided at the upper portion of the cutter cover so as to be parallel to the first slit, the second slit extending internally along the scanning direction.

5. The image recording device according to claim 4, wherein
the transport unit includes:
a first roller pair disposed upstream of the recording unit in the transport direction;
a second roller pair disposed between the recording unit and the cutting unit in the transport direction; and
a third roller pair disposed downstream of the cutting unit in the transport direction, and
the second slit is disposed between the second roller pair and the cutting unit in the transport direction.

6. The image recording device according to claim 1, further comprising:
a display unit configured to display information;
a sensor configured to detect a position of the cutter carriage; and
a control unit, wherein
when the first cutter does not return to a predetermined position, the control unit stops driving the cutting unit, and indicates that the protruding portion is to be operated, on a basis of detection information from the sensor.

7. The image recording device according to claim 1, wherein
the transport unit includes:
a first roller pair disposed upstream of the recording unit in the transport direction;
a second roller pair disposed between the recording unit and the cutting unit in the transport direction; and
a third roller pair disposed downstream of the cutting unit in the transport direction, and
a handle grip section is provided at at least one roller pair of the first roller pair, the second roller pair, and the third roller pair such that the handle grip section is provided at one of rotary shafts that constitute the one roller pair, the handle grip section being configured to rotate on the rotary shaft.

8. The image recording device according to claim 1, wherein
the transport unit includes:
a first roller pair disposed upstream of the recording unit in the transport direction;
a second roller pair disposed between the recording unit and the cutting unit in the transport direction; and
a third roller pair disposed downstream of the cutting unit in the transport direction, and
the image recording device includes:
a through hole extending internally and disposed at a portion of the transport path that corresponds to upstream of the first roller pair in the transport direction, the through hole being disposed at an identical height to the first roller pair; and
a door section configured to open and close the through hole.
